(19) United States
(12) Patent Application Publication
(10) Pub. No.: US 2014/0379617 A1
(43) Pub. Date: Dec. 25, 2014

(54) METHOD AND SYSTEM FOR RECOMMENDING INFORMATION

(71) Applicant: Alibaba Group Holding Limited, George Town (KY)

(72) Inventors: Tao Yang, Hangzhou (CN); Jianmin Huang, Hangzhou (CN); Qinyu Wang, Shanghai (CN); Pun Kok Chia, Hangzhou (CN)

(21) Appl. No.: 14/305,903

(22) Filed: Jun. 16, 2014

(30) Foreign Application Priority Data
Jun. 19, 2013 (CN) 201310244580.4

(51) Int. Cl. G06N 5/04; G06N 99/00

(52) U.S. Cl. CPC G06N 5/04; G06N 99/005
USPC 706/12; 706/46

(57) ABSTRACT

Embodiments of the present application relate to a method for recommending information, a system for recommending information, and a computer program product for recommending information. A method for recommending information is provided. The method includes determining a set of specific first users comprising at least one specific first user who complies with a first preset condition, the determination being based on operating behavior information of a set of one or more first users recorded in a system, looking up, in the set of specific first users, targeted specific first users having a similarity to a current user who complies with a second preset condition, and providing recommendation information to the current user based on the operating behavior information of the targeted specific first users.

### CROSS REFERENCE TO OTHER APPLICATIONS

This application claims priority to People's Republic of China Patent Application No. 201310244580.4 entitled METHOD AND DEVICE FOR RECOMMENDING INFORMATION, filed Jun. 19, 2013 which is incorporated herein by reference for all purposes.

### FIELD OF THE INVENTION

The present application relates to a method and a system for recommending information.

### BACKGROUND OF THE INVENTION

Users receive recommendation information in many fields. For example, in order to provide enhanced service to both buying and selling users, third-party e-commerce transaction platforms (also known as “transaction platforms”) are, in addition to implementing basic functions, continually updating their own recommendation functions. For example, because many seller-users on transaction platforms exist and a very large quantity of product information is published on the transaction platforms, determining how to help buyer-users more conveniently and quickly find desired product information is something that is to be considered along with efforts to update the seller-users' functions. Conventionally, finding desired product information is typically accomplished by recommending to buyer-users other product information similar to the product that the buyer-users are currently viewing (i.e., if, while viewing a product, a user is not satisfied with the current product, the user is to view another similar product) or recommending other product information related to the product that the user is buying (i.e., if a user purchases a certain product, such as a cell phone, the user might also purchase other products, such as a charger or other cell phone accessories, complementing the product). Such recommendations can reduce search efforts of users. If the recommendations are sufficiently accurate, the user can directly click on a link to perform a purchase or other operation, thus the recommendations can increase transaction opportunities for both buying and selling users.

However, this approach to recommendation which is based on the relevance (including similarity or correlation) between products often overlooks personalized differences between users in relation to need or preference. In other words, whenever a user views product A, a recommendation that the transaction platform typically provides is product B. As a result, the probability that the recommendation result can truly satisfy the user is not likely. The majority of the recommendation results may be ignored by the user. In addition, ensuring the quality of the recommended product information can be difficult. Even if the current buyer-user is truly interested in the recommendation result, the recommendation provided by the transaction platform is to be invalid if the buyer-user ends up purchasing a product that has a quality problem or another problem and possibly has to undergo a product return or replacement process. Not only would this approach waste network resources, but also the approach would reduce the buyer-user's confidence in the transaction platform and satisfaction of the user's experience.

### BRIEF DESCRIPTION OF THE DRAWINGS

Various embodiments of the invention are disclosed in the following detailed description and the accompanying drawings.

In order to provide a clearer explanation of the technical solutions in the prior art or in embodiments of the present application, simple introductions are given below to the drawings which are needed for the embodiments. Obviously, the drawings described below are merely some embodiments of the present application. Persons with ordinary skill in the art could, without expending creative effort, obtain other drawings on the basis of these drawings.

FIG. 1A is a flowchart of a first embodiment of a process for acquiring a weight of a specific variable.

FIG. 1B is a flowchart of a second embodiment of a process for acquiring a weight of a specific variable.

FIG. 1C is a flowchart of an embodiment of a process for recommending information.

FIG. 2 is a diagram of an embodiment of a device for recommending information.

FIG. 3 is a diagram of an embodiment of a similar superior buyer-looking up unit.

FIG. 4 is a diagram of an embodiment of a similarity-calculating unit.

FIG. 5 is a diagram of an embodiment of an information-recommending unit.

FIG. 6 is a diagram of an embodiment of a recommending unit.

FIG. 7 is a diagram of an embodiment of a system for recommending information.

FIG. 8 is a functional diagram of an embodiment of a computer system for recommending information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, buyer-users in a transaction platform system are referred to as “first users” and seller-users are referred to as “second users.” The relationship between “first users” and “second users” can be understood as being limited to a buying and selling relationship. In some embodiments, the relationship can also be between an issuing party (a “first user”) and a receiving party (a “second user”) and involve an operating action in another system. The technique is also applicable to first user-second user relationships involving two sets of users having different roles.

In order to increase the effectiveness of recommendation information, personalized recommendations can be provided for different users. For example, the system provides recommendations based on similarities between the current user and each first user in the system. In other words, N first users who are most similar in shopping preferences and in other respects to a current user A are found from the first users. Then, based on historical operating action records of the N first users, the system provides the current user A with recommendation information. For example, if the first users refer to the buyer-users, the historical purchase records of the buyer-users that are most similar to the current user is used as a basis for recommending to the current buyer-user product information, shop information, or other information that might interest the current buyer-user. In other words, if two users have similar operating behaviors or are similar in other ways, the operating object of one of the users is possible to also be liked by the other user. The operating object refers to current buyer-user product information, shop information, or other information. This principle is employed by a recommendation approach to be later described. Therefore, this recommendation approach can increase the effectiveness of the recommendation results.

In some embodiments, in implementing the information recommendation approach, based on similarities between users described above, the N first users, who are most similar to the current user, are to be found from among all first users in the system. Yet, the system may contain an extraordinarily large number of first users, and thus the amount of computations to be performed may be enormous, resulting in a great expenditure of system resources. In addition, the quality of the recommendation result provided to the current user cannot be known. Quality of the recommendation result refers to the quality of current buyer-user product information, shop information, or other information. Thus, even if the current user is truly interested in the recommendation result, the recommendation made by the transaction platform proves invalid if the user ends up purchasing a product that has a quality problem or other problems and possibly has to enter a product return or replacement process. In addition, the recommendation made by the transaction platform would lower the user's confidence in system recommendations.

Thus, in some embodiments, the following process is adopted: when recommending information based on a similarity between users, searches for first users who are similar to the current user in operating behavior or other respects are conducted within a set of specific first users only. In some embodiments, the set of specific first users corresponds to a subset of all first users in the system. Although all the first users in the system are issuing parties with respect to operating actions, the “quality” of different first users will vary. In some embodiments, “quality” is derived by counting the records of historical operating behavior information. For example, for a buyer-user on an e-commerce transaction platform, this “quality” embodies buyer-user positive evaluation rates (positive evaluation rates relate to the ratio of positive reviews to total reviews (including good reviews, average reviews, negative reviews, etc.)), the ratio of product return frequency to purchase frequency (the product return frequency relates to a ratio of number of returns to total number of purchases), etc. These examples are used to evaluate the quality of the users, i.e., high quality or superior seller-users who typically sell high quality or superior products with high positive evaluation rates and low return product rates. Similarly, buyer-users who purchase high quality or superior products (from seller-users who are deemed to sell high quality or superior products and have a low rate of return) are deemed to be high quality or superior buyers. On the other hand, low quality or inferior buyers typically buy from low quality or inferior sellers. Thus, when information is recommended according to the historical operating behavior of the first users most similar to the current user, these recommendations are the equivalent of making recommendations based on the operating behavior information of some specific first users. Thus, on the one hand, because the specific first users are a subset of all first users, computing volume is greatly reduced when similarities are computed. On the other hand, the specific first users often can be higher-quality first users. Therefore, the recommended information has an increased quality, and the effectiveness of final recommendations is also greatly increased.

When a set of specific first users is being extracted from all first users, quality of first users can be calculated first (e.g., the quality is expressed as a score) with a portion of higher-scoring first users being set aside as specific first users. In some embodiments, when the quality score of each first user has been calculated, the system, in addition to considering the attribute information belonging to each first user, also considers “quality” of related second users. “Related” refers to the fact that an operating action occurs between the two users. For example, a buyer-user purchased a product from a seller-user. Thus, these two users are considered to be related to each other. In other words, the operation objects of operating actions generated by first users in the system are typically certain business objects (such as products and services) offered by second users. Moreover, in some embodiments, a very large number of second users exist. Some of the second users are higher quality second users, while some second users are of lower quality. Examples of seller-users being of a lower quality or inferior include seller-users that have a low rate of positive reviews and/or a high rate of returns. If the second users related to a first user are always of higher quality, then the business objects corresponding to the historical operating actions of the first user are typically of a higher quality as well. When information of the business objects from higher quality second users is recommended to the current user, the effectiveness of the recommendation will be greatly increased. Therefore, the quality of the recommendation information of the business objects will also be higher. As for second users, in some embodiments, the quality level of the second users is derived by counting some or all of the attribute information recorded in the system. For example, some seller-users on an e-commerce transaction platform are, according to product quality, shipment speed, and other aspects assessments, able without exception to provide superior products, services, or a combination thereof. The quality of such seller-users is to be higher than the quality of the other seller-users. Also, some seller-users who are of a lower quality exist. The lower quality seller-users provide relatively lower quality of the products, services, or a combination thereof.

In other words, when determining the quality of the first users, the quality of the second users to which the first users are related can also serve as one of the criteria. For example, if a buyer-user can differentiate which seller-users among a large number of seller-users are of higher quality and which seller-users are of lower quality, the quality differentiation illustrates that the buyer-user has the ability to determine superior seller-users. In other words, a higher probability that the product objects which the buyer-user purchased are superior products and that the shops of the seller-users related to the buyer-user are superior shops exist. Therefore, points can be added to the quality evaluation of this buyer-user.

For example, when specific first users are identified among the first users, a quality score of each second user is first totaled. However, the quality of second users in fact is related to the quality of the first users to which the second users are related. For example, if the shop of a seller-user regularly attracts higher quality or superior buyer-users, the attraction illustrates that a higher probability exists that this seller-user is able to provide superior products or services. When determining a degree of quality of the products or services, additional points should be awarded accordingly. Therefore, in actual applications, first users and second users may influence or boost each other's quality levels.

To facilitate description, superior first users who meet the aforesaid conditions are referred to as “specific first users” and superior second users are referred to as “specific second users.” Examples of conditions include good reviews, low return rate, etc.

In other words, to recommend information more effectively, a set of specific first users is to be established. In other words, some specific first users are to be chosen from among all first users. For example, the specific first users on an e-commerce platform are: buyer-users who are very familiar with Internet shopping processes, who have a deep relationship with the e-commerce transaction platform, and are good at discovering superior seller-users or shops. In other words, the specific first users are elite or higher quality first users. The elite or higher quality first users have a thorough understanding of information relating to a field within the system and are good at operations such as collecting, choosing, and ultimately completing transactions. Therefore, the operation object (e.g., a product offered by a seller-user) corresponding to the operating action of a specific first user typically is of superior quality. In addition, due to similarities in operating behavior to the current user, information recommended to the current user that is based on similarities to the specific first users is much more likely to satisfy the current user. Moreover, the recommended information is also to be superior and is to ensure the effectiveness of the recommendation results.

In some embodiments, specific first users are also discovered through data mining. For example, a system in an e-commerce transaction platform is to save data relating to various buyer-users and seller-users in a database. This data includes historical purchasing behavior information on each buyer-user. The historical purchasing behavior information includes product information and information on seller-users relating to each transaction that each buyer-user previously completed. In addition, the system also stores statistical information data on each seller-user. The data statistical information typically includes conditions of seller-users in the values of a plurality of variables (including positive evaluation rate, proportion of transactions by repeat customers, order-to-shipment time, etc.). Therefore, this statistical information data can be effectively analyzed and mined to find superior buyer objects therein, i.e., specific first users. Accordingly, the subjectivity and narrowness associated with artificial designations can be avoided and specific first users can be found in an objective and comprehensive way.

In one example, when specific first users are discovered through data mining, a calculation model is employed to establish a method for scores of first users evaluating the first users' quality. Then, a specific calculation model is used to calculate the score of each first user and then to determine whether the first users are specific first users based on their scores. In other words, the operating behavior information of each first user recorded in the system is used to calculate the score of each first user. First users having a score greater than a predetermined threshold value are determined to be specific first users that comply with preset conditions. In some embodiments, when building the specific first user computation model during a specific implementation, only some operating behavior information on first users are considered. For example, in the case of first users who are buyer-users, the operating behavior information considered includes purchasing frequency of the first users who are buyer-users, return frequency, positive evaluation rate by seller-users of buyer-users, etc. An example of a calculation model is ax+by+cz, where x represents purchasing frequency, y represents return frequency, z represents positive evaluation rate, and a, b, and c represent weights. Another example of a calculation model is ax*y+cz, or any other calculation model that computes the user's quality. However, as stated above, specific first users and specific second users typically influence each other. Therefore, in building a computation model for specific first users, superior qualities of second users related to first users are considered. In other words, when acquiring the operating behavior information of the first users, the following information is included: whether or not the second user related to the first user in each operating action is a specific second user. For example, if many superior buyer-users go to the shop of a seller-user to make purchases, the quality of this seller-user typically will not be poor. If many shops corresponding to the purchasing actions of a buyer-user are superior seller-user shops, then this buyer-user has relatively good “taste” and is good at discovering the shops of superior seller-users. The process is iterative. Therefore, in some embodiments, in order for the established computation model to better comply with actual conditions, such a correlation is embodied within the model. In other words, a determination is made as to whether a first user is a higher quality (superior) or not is associated with whether the related second users are of a higher quality (superior) or not. In addition, the determination of whether a second user is superior or not varies with the first users to which the second user is related.

Thus, in some embodiments, the present application is implemented in the following manner: the information recorded in a system about second users that act as recipients of operating actions is typically relatively comprehensive, which is the equivalent of the system having a better “understanding” of second users. Because the system's log information for seller-users is more comprehensive, for example, the system's log information of seller-users includes positive feedback rate, return rate, etc. in comparison to the system's log information for buyers, the system has a better “understanding” of the sellers. Therefore, the system first computes quality score base values for second users and thereby initially determines specific second users based on the computed quality score base values. Then, based on whether second users related to first users are specific second users, the system determines a proportion of first user-related specific second users and other such information. The system then determines whether first users are specific first users. In other words, during initial establishment of a set of specific second users, the status of the first users related to the set of specific second users is not necessarily considered first, but instead the system selects the set of specific second users solely based on the values of each variable (such as positive evaluation rate, repeat customer transaction ratio, “treasure” online close rate, “treasure” bookmarking rate, percentage shipping DSR higher than industry, or any other variable shown in Table 1). This selection of the set of specific second users is the equivalent of being able to obtain a first batch of specific second users. Next, the system determines whether first users are specific first users in light of second users' operating behavior information and statuses of the specific second users. Thus, the first batch of specific first users can be obtained based on the set of specific second users. Thereupon, the system re-appraises whether first users are specific first users and whether second users are specific second users based on the newly acquired operating behavior information. The system then updates the set of specific first users and the set of specific second users. In some embodiments, regardless of whether the updating is directed at a first user or a second user, the updating process always takes into account whether the first user is a specific first user, or whether the second user is a specific second user. In other words, the system embodies the mutual boosting between specific first users and specific second users. The system typically records statistical data on each second user. In some embodiments, the statistical data includes second user values in a plurality of preset variables. In this way, when a set of specific first users and a set of specific second users are being specifically acquired, the system can proceed as follows:

First, the system determines a score of each second user based on a value of each second-user variable, and confirms second users having a score greater than a preset threshold value as a first batch of specific second users. Then, the system determines whether the second users related to a first user in each first-user operating action are specific second users based on first-user operating behavior information and an already acquired set including the first batch of specific second users. The system then calculates the score of each first user. Thus, the system confirms first users having scores greater than a preset threshold value as a first batch of specific first users.

Then, in some embodiments, the system repeats the update of the set of specific first users and the set of specific second users as follows: the system re-determines whether each first user is a specific first user based on new operating behavior information generated by first users within a designated interval of time and whether the related second user in each operating action is a specific second user. Moreover, the system updates the set of specific first users based on the re-determination results. Then, the system re-determines whether each second user is a specific second user based on new operating behavior information generated by second users within a designated interval of time and whether the related first user in the new operating information is a specific first user. Moreover, the system updates the set of specific second users based on the re-determination results.

In other words, in the updating operation, the scores of all first users and second users in the previous operation serve as base values on which the scores of the first users and the second users are subsequently updated.

The above-described process is described below using examples of buyer-users (corresponding to the first users) and seller-users (corresponding to the second users) on an e-commerce platform and statistical information recorded for various users on the platform.

First, because information recorded in the transaction platform system about seller-users is typically more comprehensive than buyer-users, the system has a better “understanding” of sellers. Therefore, in some embodiments, mining begins with statistical data relating to seller-users. The statistical data relating to the seller-users is then used to determine specific buyer-users. As the seller-user-related statistical data is mined, in other words, as seller-users are initially scored (e.g., their scoring is called a “superior quality index”) according to this statistical data, possible superior seller-users may be found within the statistical data. Of course, this process has not yet considered whether buyer-users have an impact on seller-users. Therefore, a superior quality index obtained through scoring of the higher quality of the seller-users is called a “unilateral superior quality index.” (After the superior quality index is updated according to superior buyer-user information, the unilateral superior quality index becomes the “bilateral superior quality index.”) The unilateral superior quality index for each seller-user, after being obtained, serves as a base value of the seller-user superior quality index, and seller-users having a base value that satisfies a certain condition (e.g., the positive feedback rate is higher than A (e.g., 80%), the return rate is lower than B (e.g., 10%)) become superior seller-users (i.e., specific second users). Satisfying the certain condition is the equivalent of having obtained some basic information on whether seller-users are of superior quality. Thereupon, using this basic information, the system can start determining whether buyer-users are of superior quality.

First, the system obtains a unilateral superior quality index of a seller-user from the system's statistical data as presented below.

In some embodiments, the unilateral superior quality index of a seller-user represents whether a seller-user is a superior quality seller-user. Therefore, when a seller-user's superior quality index is calculated, the superior quality index can be based on values of one or more variables. For example, the superior quality index is based on a positive feedback rate (e.g., percentage of ratings are at least four stars or above, percentage of ratings that include positive words like “excellent,” “good,” “satisfied”), a proportion of previous buyer-users who purchase again, etc. If different criteria are used to determine whether a seller-user is of a superior quality, different results may be obtained. For example, if the superior quality index is determined based on the factor of “positive feedback rate,” seller-user A's corresponding value is to be relatively high. In this case, the seller-user A is of superior quality. However, if the superior quality index is determined based on the factor of “repeat customer transaction ratio,” seller-user A's corresponding value will be relatively low, in which case seller-user A cannot be regarded as of superior quality. In some cases, some seller-users are determined to be of a superior quality as assessed from several different factors corresponding to a plurality of variables. Therefore, these seller-users are regarded as being of superior quality for any of a plurality of variables. Also, some seller-users exist who when determined from different variables are found not to be superior according to any of the variables. Therefore, these seller-users may be regarded as being of a non-superior quality. A large number of variables recorded for seller-users in the system can exist. In some cases, more than a hundred variables can exist. It is not very practical to expect that seller-users have high values in all these variables. Moreover, even if some seller-users have high values in all these variables, these seller-users would constitute a very small proportion of the seller-users, leading to a data-poor result. Then, determining whether buyer-users were of superior quality would not be possible.

Therefore, in some embodiments, to comprehensively evaluate the superior quality index of second users, the system first selects some specific variables. These specific variables are variables that can embody definite distinctness levels between different specific types of second users. For example, assume that second users are to be simply divided into two groups: superior second users and non-superior second users. In this example, second users are clustered separately according to each variable. Variables that are capable of dividing second users clearly into the two types of superior and non-superior and do so with an obvious boundary are identified. In some embodiments, these variables are extracted as specific variables. Next, in some embodiments, these specific variables are used to score second users. The N highest-scoring second users serve as extreme samples of specific second users. In other words, these N second users have highly obvious superior quality features. Therefore, these N second users are labeled as extreme samples. Of course, extreme samples having non-superior features can also be labeled according to the same logic. In other words, second users can undergo a plurality of clustering processes based on each variable. Those variables which can cluster the second users into preset types and can manifest preset distinctness levels between various types are confirmed as specific variables.

Please note that, where second users correspond to seller-users on a transaction platform, in the clustering of the seller-users based on each variable, some seller-users may have a higher chance of obtaining higher values for some of their variables as a result of their shops being relatively large. Some other seller-users may not have such high values for some of their variables. As an aspect, a reason for some other seller-users not having such high values for some of their variables might be the fact that their shops are relatively small and the probability that their products will be discovered by buyer-users is correspondingly smaller. The fact that their shops are relatively small does not mean that these seller-users cannot provide superior products or services. On the other hand, small-scale seller-users of this sort can be seller-users that provide unique or personalized products or services. Therefore, if seller-users are scored by simply using variables that can cluster seller-users into the two types of superior and non-superior, some relatively small yet actually very superior seller-users end up unable to obtain relatively high scores and can be mistakenly viewed as non-superior seller-users with the end results being that the shops or products of such seller-users are not being recommended to buyer-users.

Therefore, in some embodiments, in order for the seller-user unilateral superior quality index to more truly reflect actual conditions, shop size is considered when selecting specific variables. In some embodiments, among the various variables, shop GMV (Gross Merchandise Volume, the monetary value of website transactions) typically reflects the business scale of a shop. Therefore, this single variable is extracted, and each clustering is performed as a two-dimensional clustering. In other words, one of the dimensions is sales volume, and the other dimension is one of the various other variables. Thus, in some embodiments, when selecting specific variables, one observes which variables have clustering results that cluster seller-users into the four types: “small and beautiful” (i.e., shop is small and of superior quality), “small and ugly” (i.e., shop is small and of non-superior quality), “big and beautiful” (i.e., shop is large and of superior quality), and “big and ugly” (i.e., shop is large and of non-superior quality), and which variables have distinct boundaries between the four types and confirm these variables as specific variables. In other words, these variables can differentiate between large shops and small shops. Moreover, these variables can differentiate superior shops from non-superior shops among large shops and can also differentiate superior shops from non-superior shops among small shops.

For example, on a transaction platform, the specific variables that comply with the conditions described include one or more of the following variables: a positive evaluation rate, a repeat customer transaction ratio, a “treasure” online close rate, a “treasure” bookmarking rate, a percentage shipping DSR (Detail Seller Rating, a seller service rating system) higher than industry average, percentage quality DSR higher than industry average, percentage service DSR higher than industry average, percentage logistics DSR higher than industry average, an IPV conversion rate (wherein PV refers to “page views,” i.e., number of times that page is browsed; IPV refers to PV for product detail pages), familiar customer unit price/ordinary customer unit price, IPV ratio from internal website searches, response rate for related instant messaging products, order-to-shipping time, etc.

In other words, the above variables cause sellers to have significant differences in the following: “small and beautiful” and “big and beautiful,” “small and beautiful” and “small and ugly,” “small and beautiful” and “big and ugly,” and “big and beautiful” and “big and ugly.”

In some embodiments, after obtaining the above specific variables, the system directly adds the values of these specific variables together for each second user and regards the results as the second user superior quality index score. In some embodiments, the values are normalized as appropriate to ensure the same scaling for different variables. As an aspect, although all these variables are of superior quality, each variable can vary as to its importance in embodying levels of distinctness between various types. Therefore, if such distinctness fails to be embodied, the second user superior quality index scores that are calculated will also fail to accurately represent actual conditions. Therefore, in some embodiments, the system continues to mine the data to acquire a weight for each specific variable and use the weight to represent its importance in embodying levels of distinctness between types. Then, the system establishes a formula for calculating second user scores based on the specific variables and the respective weights of the specific variables. A value is substituted for each specific variable in the formula for each second user, and the superior quality index base value is thereby calculated for each second user.

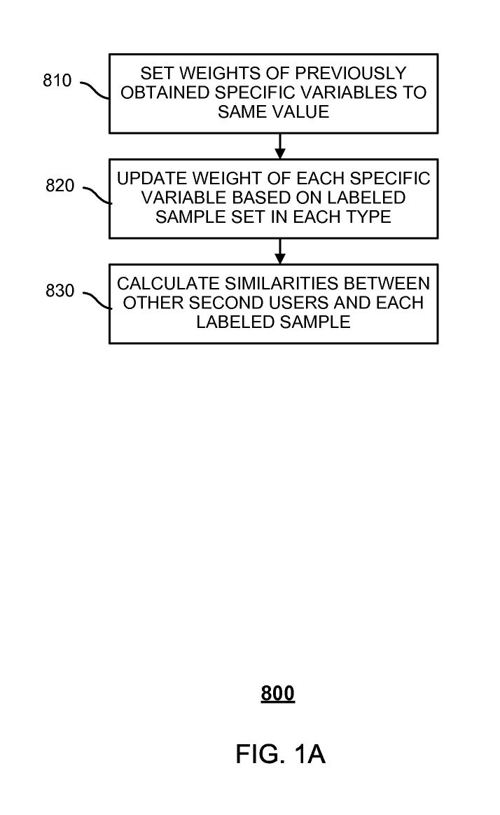

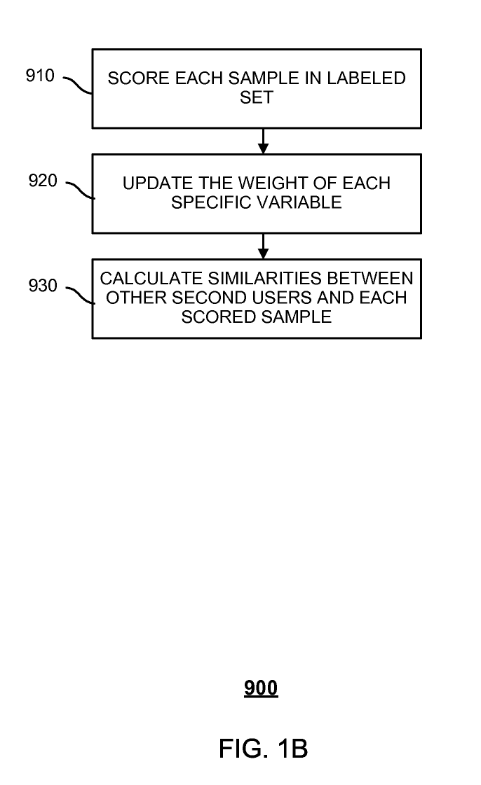

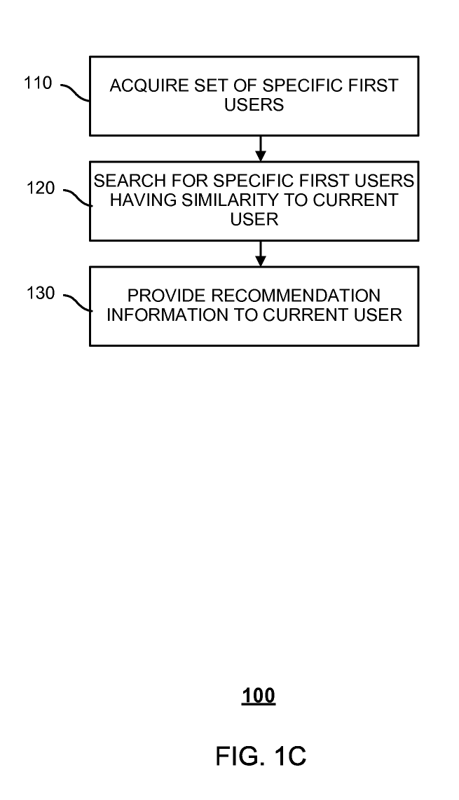

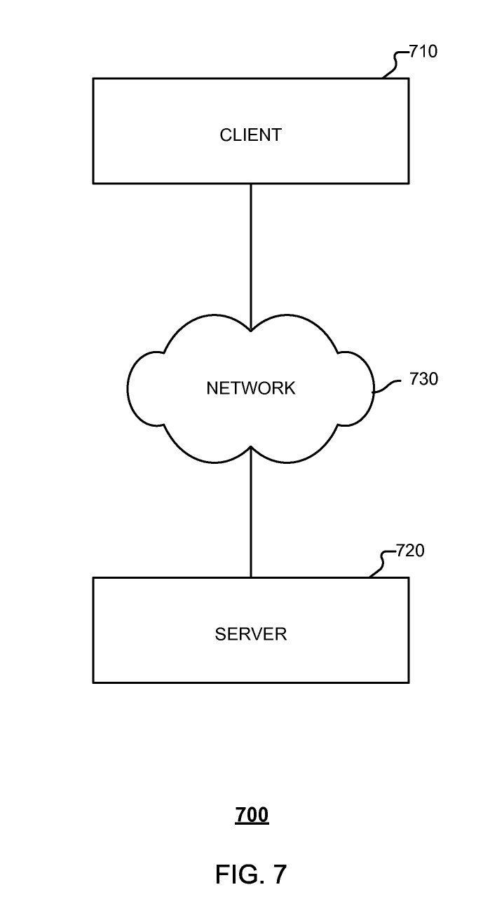

In some embodiments, to acquire the weight of each specific variable, a semi-supervised classification and regression approach is employed in conducting type labeling and scoring of each second user, and the weight of each specific variable is calculated in this process. FIG. 1A is a flowchart of a first embodiment of a process for acquiring a weight of a specific variable. In some embodiments, the process 800 is implemented by a system 700 of FIG. 7 and includes:

In 810, the system sets weights of previously obtained specific variables to the same value. For example, the system sets the initial value of each weight to 1. Then, the system scores each second user based on the specific variables and the initial weight of each specific variable, and labels a preset number of the highest-scoring second users in each type as extreme samples in the corresponding type. For example, this first operation is equivalent to separately calculating the scores of each seller with these specific variables and labeling the N highest-scoring sellers in each type as extreme samples in the corresponding type. In other words, some extreme samples can be obtained for all four types of “small and beautiful,” “large and beautiful,” “small and ugly,” and “large and ugly.” These samples possess very obvious features for a type. Whether the weight of each specific variable is calculated with equal initial values or with values more nearly approximating actual conditions, all the scores calculated from these variables should be the highest within their associated types. Therefore, these second users can serve as extreme samples in the corresponding types.

Then, a semi-supervised classification process is used to conduct loop learning a preset number of times, progressively updating the weight of each specific variable based on the extreme samples. In some embodiments, the following operations are performed during each learning:

In 820, the system updates the weight of each specific variable based on the labeled sample set in each type. In some embodiments, during the first learning operation, the labeled sample set is composed of extreme samples.

In 830, the system calculates similarities between other second users and each labeled sample, conducts type labeling of second users having a confidence interval that satisfies a preset condition to add the newly labeled second user to the labeled sample set of the corresponding type, and makes the labeled sample set available for the next semi-supervised classification learning. For example, in the event that a similarity between seller-user A and extreme sample B is higher than a threshold value, the seller-user A is added to the labeled sample set. Moreover, extreme sample B belongs to the type of “small and beautiful.” Thus, seller-user A may also be labeled as the “small and beautiful” type, etc. in this fashion. In some embodiments, the similarity between each unlabeled seller-user and each extreme sample is separately calculated. The n % of seller-users with the highest confidence levels (a concept in semi-supervised classification) are labeled as corresponding types, and the samples contained in each type are updated. Moreover, the system returns to the second operation 820 to update the weights of the specific variables. After a plurality of loop learnings, the weight of each specific variable is obtained.

The second users are labeled with their associated types based on the above semi-supervised classification process, and the weight of each specific variable is calculated and updated. After each updating, more knowledge is gained with the result that the weight of each specific variable more closely approximates actual conditions. Of course, during the semi-supervised classification, the weights of specific variables are calculated and updated based on the labeling result for each second user. The labeling result is discrete information. In other words, labeling each second user as belonging to one type or another is possible, which corresponds to not differentiating between “superior quality” degrees between various second users for each type. But, in reality, the various second users within a single type can have different degrees of “superior quality.” If no differentiation is performed with respect to the different degrees of “superior quality,” the weights of specific variables obtained through calculations and updating will continue to fail to more closely approximate true conditions. In other words, the weight of each specific variable calculated and obtained using the semi-supervised classification approach will continue to be insufficiently precise. Therefore, in some embodiments, the weights of each specific variable are to be determined through semi-supervised regression. An example of an embodiment of a semi-supervised regression process is described below in process 900 of FIG. 1B.

FIG. 1B is a flowchart of a second embodiment of a process for acquiring a weight of a specific variable. In some embodiments, the process 900 is implemented by a system 700 of FIG. 7 and includes:

In 910, the system scores each sample in the labeled set based on the weight of each specific variable obtained with a semi-supervised learning process. In some embodiments, the labeled set includes extreme samples obtained during the initial learning.

In 920, the system updates the weight of each specific variable based on the samples in the scored sample set.

In 930, the system calculates similarities between other second users and each scored sample, scores second users having a confidence interval that satisfies a preset condition, and adds the newly scored second user to the scored sample set of the corresponding type to make the newly scored second user added to the scored sample set of the corresponding type available for the next semi-supervised regression learning. In other words, the system calculates the similarities between other unlabeled second users and the extreme samples to find the n % of seller objects with the highest confidence levels. And the system assigns scores based on specific variables and current weights. Subsequently, control returns to the second operation 920, and again the weights of specific variables are updated. After performing this loop learning several times, the system obtains a final weight of each specific variable.

In other words, in the process of semi-supervised regression, weights of specific variables are updated based on the score for each second user. As a result, more detailed scoring information is gained in addition to the types associated with each second user. Therefore, the specific variable weights obtained based on this more detailed information update more closely approximates actual conditions.

In short, through the multiple loop updating in the semi-supervised classification and regression processes, determining the weight for each specific variable that was previously obtained is possible. These weights relate to the importance of each specific variable with respect to levels of distinctness between the various types.

After the weight of each specific variable is obtained, generation of a formula for calculating the second user unilateral superior quality index is possible. In actual implementations, this formula is sometimes referred to as the “superior quality index scorecard.” For example, the final weights corresponding to the various specific variables are shown in Table 1:

TABLE 1

| Variable | Weight |
|---|---|
| Positive evaluation rate | 10.6 |
| Repeat customer transaction ratio | 1.9 |
| “Treasure” online close rate | 1.8 |
| “Treasure” bookmarking rate | 1.6 |
| Percentage shipping DSR higher than | 1.4 |
| industry | |
| Percentage quality DSR higher than | 1.2 |
| industry | |
| Percentage service DSR higher than | 1.1 |
| industry | |
| Percentage logistics DSR higher than | 0.4 |
| industry | |
| IPV conversion rate | 0.3 |
| Familiar customer unit price/ordinary | 0.2 |
| customer unit price | |
| IPV ratio from internal website searches | −0.2 |
| Response rate in related instant messaging | 0.2 |
| products | |
| “Zhitongche” (a multi-engine search | −0.1 |
| program) and “Taobaoke” (a pay-by- | |
| transaction promotional model)-guided IPV | |
| ratio | |
| Order-to-shipment time | −0.04 |

The formula for calculating second user unilateral superior quality index scores relates to multiplying each variable in Table 1 by its corresponding weight and then adding the results of each multiplication together. In some embodiments, the system then substitutes the value for each specific variable described above into the formula separately for each second user. The resulting scores can serve as unilateral superior quality index scores corresponding to the second users.

Although the semi-supervised learning process involved scoring second users, the scores are only intermediate values in the learning process and are not the final resulting scores. In some embodiments, only the values calculated after obtaining the above-described formula serve as unilateral superior quality index scores for second users.

After the unilateral superior quality index scores are obtained for the second users, the unilateral superior quality index scores can serve as base values for bilateral superior quality index scores. Moreover, in some embodiments, the N second users with the highest bilateral superior quality index scores serve as current specific second users. Subsequently, as second user bilateral superior quality index scores change, the specific second users included in the set of specific second users can also change.

A description of an embodiment of the process for acquiring second user bilateral superior quality index base values was provided above. The acquisition of these base values corresponds to providing a foundation for the discovery of specific first users. Next, how specific first users are to be discovered based on the second user superior quality index is to be described.

First of all, in some embodiments, for first users, first user “superior quality index” scores are calculated based on historical operating behavior information recorded in the system, and the first user “superior quality index” scores serve as first user superior quality index base values. As an example, the historical operating behavior information generated by first users at each second user within a relatively long period of time serves as a basis for determining first user superior quality index scores, which serve as the first user bilateral superior quality index base values. When the first user superior quality index scores are obtained, the first user superior quality index scores can be obtained based on a frequency of purchasing actions by first users within a preset time interval, frequency of product object views, number of second users corresponding to purchasing actions that are specific second users, first user ratings, the weights for the parameters described above, or any combination thereof. For example, the specific formula corresponds to the formula (I) below:

First user bilateral superior quality index base value=Tr(\tilde{T}r(Frequency of purchasing actions occurring within preset time interval)×A1+\tilde{T}r(Frequency of product object views within preset time interval)×A2+Tr(Number of second users corresponding to purchasing actions that are specific second users)×A3+\tilde{T}r(Ratings of first users)×A4) (1)

where A1, A2, A3 and A4 are weights corresponding to the various parameters, and A1+A2+A3+A4=1;

$$\begin{matrix}Tr ( x ) = \frac{x - min ( x )}{max ( x ) - min ( x )} * 100 & ( 2 ) \\ \tilde{T} r ( x ) = \frac{P ( x ) - min ( x )}{{Percentile}_{0.9} ( x ) - min ( x )} * 100 & ( 3 ) \\ P ( x ) = \{ \begin{matrix}x & if ( x < {Percentile}_{0.9} ( x ) ) \\ {Percentile}_{0.9} ( x ) & if ( x \geq {Percentile}_{0.9} ( x ) )\end{matrix} & ( 4 )\end{matrix}$$

where, the functions Tr(x) and \tilde{T}r(x) in the data processing process provide technical treatment to render the results more reasonable; Percentile_{0.9}(x) is a 0.9 quantile function.

During calculation of the score base values for the first users, consideration was given to information such as whether the second users related to the first users were specific second users. Therefore, no “unilateral superior quality index” exists for first user scores: all scores are bilateral superior quality index scores. However, the scores that were initially acquired as base values can undergo several subsequent updates. After obtaining the bilateral superior quality index base values for each first and second user, a mathematical model for updating the second user bilateral superior quality index and the first user bilateral superior quality index is established. In some embodiments, the mathematical model is capable of embodying mutually-influencing and mutually-boosting relationships between the specific second users and the specific first users.

In some embodiments, during implementation, the first user superior quality index is updated based on information such as second user superior quality index scores corresponding to first user purchasing actions within a certain time interval. After completing several updates, the process stops itself. In some embodiments, bilateral superior quality index values for each first user are obtained, and first users having higher bilateral superior quality index scores are specific first users. After using the second user superior quality index to update the first user superior quality index scores, the first user superior quality index scores embody the effects of the second users.

For example, in actual applications, the first user bilateral superior quality index is updated using formula (5) below:

First user bilateral superior quality index=ω×Bilateral superior quality index of the first user in the previous operation+[(1−ω)×I(Number of first user-related specific second users≧Q)×Σ(Previous-operation second-user bilateral superior quality index)×(Number of times that the first user engaged in operating actions at the second user/(Total number of times that the first user engaged in operating actions))]

where:

$$I ( x ) = \{ \begin{matrix}1 & if x is there \\ 0 & other\end{matrix} \qquad ( 5 )$$

In other words, when the first user superior quality index is being updated, the updating process involves the following information: the total number of operations by the first user in the new operating behavior information, the number of related second users which are specific second users in each operating action by the first user, the number of operations by the first user at each second user, the previous score for each second user, etc. For example, on an e-commerce transaction platform, the new purchasing behavior information generated within an interval of time (typically, updating occurs once a week, but updating may occur at other times) includes the total number of orders (i.e., purchase frequency) placed by the buyer-user, the number of seller-users related to the buyer-user that are superior seller-users, the number of orders placed by the buyer-user at each seller-user, and the superior quality index of each seller-user in the previous operation. The superior quality index of the so-called “previous operation” refers to the superior quality index of the seller-user or buyer-user in its previous state. Because the process of updating the superior quality index is an iterative process, the superior quality index calculated in the current operation is related to the superior quality index of the previous operation.

The function I(x) corresponds to the following: If the number of specific second users included among first user-related second users in the current updating period is greater than or equal to a certain value, then the function value corresponds to 1; otherwise, the function value corresponds to 0. In other words, when the first user relates to a certain number of specific second users during an updating period, then the superior quality index is to be updated. Otherwise, when the first user does not relate to a certain number of specific second users during an updating period, the first user superior quality index will remain unchanged. In this process, the superior quality of second users are to be “absorbed” by first users, and the first users' superior quality index raised, only when they are related to a certain number of specific second users. This raising of the first users' superior quality index conforms more closely to actual conditions. For example, if a buyer-user purchases product from one or a small number of superior seller-users, that does not indicate that the buyer-user possesses an ability to find superior seller-users.

In the process of updating the superior quality index for first users, the superior quality index for second users is also to be updated. Thus, the updated superior quality index not only embodies statistical data on second users themselves but also embodies the effects of first users. Therefore, the updated superior quality index gradually becomes a “bilateral superior quality index.” In some embodiments, the updating process is as shown in formula (6):

Second user bilateral superior quality index=ω×Bilateral superior quality index of the second user in the previous operation+[(1−ω)×I(Number of second user-related specific first users≧Q)×Σ(Previous-operation second-user bilateral superior quality index)×(Number of times that the specific first user engaged in operating behavior at the second user)/(Total number of times that the second user was a recipient of operating actions by all specific first users)] (6)

In short, by using the above approach, the system gradually updates the first user and second user bilateral superior quality indices and, finally, after the process ends, the system determines which first users become specific first users based on the value of each first user bilateral superior quality index.

In some embodiments, the system pre-filters second users based on second user values of designated variables. For example, on an e-commerce platform, some seller-users, who are second users have some “reputation hype.” In other words, the seller-users intentionally increase the reputations or ratings of their own shops through improper means. Therefore, these seller-users are filtered out before the superior seller-users are extracted. Then, the system selects specific second users from among the remaining seller-users. When the system specifically filters the seller-users, filters can be implemented according to the variables: ratio accounted for by normal orders (i.e., are a large proportion of seller object orders normal?), shop DSR, etc. Normal orders refer to actual, real transactions, which exclude fake transactions aimed at increasing sales volume and manipulating ratings.

In some embodiments, the system pre-filters first users based on specific operating behavior information of the first users. For example, typically, for buyer-users who are first users on an e-commerce platform, the only buyer-users who become superior buyer-users are those buyer-users who are involved in “much buying,” “much viewing,” “familiarity with Internet,” and “good taste,” and not by “reputation hype” behavior. In other words, to be superior buyer-users, the first users cannot have a purchase quantity that is relatively very small. If the purchase quantity of the first users is relatively very small, the first users will lack sufficient data to represent buyers in certain respects. Of course, the purchase quantity of the first users cannot be relatively very large either, because if the purchase quantity of the first users is relatively very large, then the first users may be wholesalers and thus be unable to represent buyers in certain respects. Therefore, before extracting superior buyers, the first users can undergo filtering.

In some embodiments, the first users are filtered based on one or more of the following variables: number of purchases within half a year, number of views within the past month, buyer object rating, ratio of normal purchase actions, and proportion of purchases by buyer objects from seller objects with “treasure” DSR below industry average.

Only those buyer-users who, for the variables above, have values that comply with requirements can enter subsequent superior quality index calculations and the process of further determining whether those buyer-users are specific first users.

In some embodiments, first users and second users typically are divided into a plurality of types. The efficiency of recommendations can be further increased when recommendation information is provided based on first users of the same type. Therefore, in some embodiments, all first users are pre-divided into at least two types according to basic attributes of the first users. Examples of basic attributes include gender (male or female), age, purchasing power, etc. Each type has its own set of specific first users. Thus, when specific first users are determined to be similar to current users, the system first identifies the type to which the current user belongs. Then, the system looks up in the set of specific first users of this type of target specific users having a similarity to the current user that complies with a precondition. Of course, if, within the set of specific first users of this type, the number of target specific first users having a similarity to the current user that complies with the condition is relatively large, recommendation information is provided to the current user according to the operating behavior information records of the target specific first users. In one aspect, if, within the set of specific first users of this type, the number of target specific first users having a similarity to the current user that complies with the condition is less than a threshold value, the system looks up, among all first users of this type, the target first users having a similarity to the current user that complies with the condition and then offers recommendation information to the current user based on the historical operating information of these first users.

For example, when the number of products on a transaction platform is very large, the transaction platform typically classifies and manages the seller-users and the buyer-users based on product category (apparel, digital, etc.). Seller-users and buyer-users typically are related in a certain way to categories. For example, a seller-user typically has a primary business category. Therefore, the seller-users can be divided into a plurality of categories according to the seller-users' primary business categories. At the same time, buyer-users typically have categories that they prefer or like. For example, some buyer-users prefer the apparel category, and other buyer-users prefer to purchase items in the digital category. Therefore, buyer-users can be divided into a plurality of buyer-user types according to the categories that the buyer-users prefer. Typically, the buyer-users that are in the same type are referred to as a “micro-group.” Of course, buyer-users who like to buy items in the apparel category may lack a sufficient understanding of items in the digital category. Similarly, buyer-users who like to buy items in the digital category may have less understanding of items in the apparel category. Therefore, in some embodiments, when determining superior buyer-users, the system determines superior buyer-users in each micro-group. Of course, the same buyer-user might be classified as a superior buyer-user in more than one micro-group.

When determining specific first users in each type, the method corresponds to what is described in the foregoing text. In some embodiments, when first user attribute information, second user attribute information, and first user-second user relationship attribute information are extracted from the system, the system is to filter the extraction to a certain scope and not to filter all the information.

For example, if the system is to extract superior buyer-users from the apparel micro-group, the system extracts buyer-user purchasing behavior information relating to apparel products when calculating buyer-user bilateral superior quality index base values. Then, when the system is updating the superior quality index, the system acquires the purchasing behavior information relating to apparel products that is newly generated within a certain time interval. In addition, when the buyer-users are being filtered, the system filters the buyer-users based on corresponding attributes of seller-users within a certain category. As for seller-users, if the system determines superior buyer-users in a certain micro-group, then the seller-users are filtered. In other words, in some embodiments, in addition to imposing “no reputation hyping” and other such conditions, the system also filters according to the primary business categories of the seller-users. If a primary business category of a seller-user is a category corresponding to the current micro-group, then the seller-user should be retained for subsequent superior quality index calculations; otherwise, the seller-user should be filtered out.

A description was provided above for the process of establishing a set of superior buyer-users. Next, information can be recommended based on the set of superior buyer-users. FIG. 1C is a flowchart of an embodiment of a process for recommending information. In some embodiments, the process 100 in implemented by a system 700 of FIG. 7 and includes:

In 110, the system acquires a set of specific first users including at least one specific first user that complies with a first preset condition based on operating behavior information of all first users recorded in the system.

Various embodiments of processes for generating the set of specific first users are discussed above.

In 120, the system searches for specific first users having a similarity to the current user that complies with a second preset condition in the set of specific first users.

When calculating similarities between the current user and the specific first users, defining similarity and what parameters to use for calculation are considered. If similarity is defined too broadly, the recommendation results may appear not to be personalized. On the other hand, if similarity is defined too narrowly, the recommendation results may be substantially impacted by noise, and the final recommendation results may be overly concentrated. Therefore, breadth of the similarity definition is to be considered.

In addition, when calculating similarity, the parameters used in the similarity calculations are to be considered. For example, some basic attributes of first users can be used as parameters. For example, a similarity between first users is calculated based on the parameters age, sex, region, purchase amount, purchase frequency, etc. As an aspect, the similarity calculated with such an approach relates to the relative similarity of first users based on basic attributes and does not relate to similarity of operating behavior. In other words, first users having basic attributes which are similar do not necessarily behave the same with respect to operating behavior.

Thus, in some embodiments, the system calculates the similarity in operating behavior between the current user and each specific first user based on the historical operating behavior information (such as purchasing) of the current user and specific first users. Then, the server confirms specific first users having a similarity that complies with a second preset condition as the target specific first users.

In some embodiments, since the historical operating behavior information includes a large amount of information, a method is to be used when calculating similarities in operating behavior between the current user and the specific first users based on the historical operating behavior information of the current user and the specific first users. After the method is performed, the calculated similarities between the users reflect the similarities in user operating behavior. For example, the method measures the similarity between two first users based on a second user jointly related to the two first users (in other words, a second user who is related to each first user individually). As an aspect, tests show that the results from such an approach for calculating the similarity are relatively crude. In some embodiments, the method performs the following: the system calculates vectors in a Euclidean space in which all second users corresponding to a first-user operating behavior are a dimension, and calculates the cosine of the angle between vectors of two first users as the similarity between two first users. In some embodiments, to determine the similarity, the system first determines second users jointly related to the current user and specific first users. Then, the system calculates the similarity in operating behavior of the current user to specific first users based on the quantity of the jointly related second users, the number of operations by the current user and specific first users, respectively, at jointly related second users, and the total number of second users related to the current user and the specific first users, respectively. For example, when first users are buyer-users, the system calculates the similarity in purchasing behavior of the current user to superior buyer-users based on the number of shops to which the current user and superior buyer-users are jointly related, the number of orders placed by the current user and superior buyer-users, respectively, in jointly-related shops, and the total number of jointly-related shops for the current user and each superior buyer-user. These “jointly-related shops” refer to shops where both the current user and the superior buyer-users have engaged in purchasing behavior. In some embodiments, the formula for calculating similarity is as follows:

$$sim ( a , b ) = \frac{{\sum }_{i} {r}_{ai} {b}_{bi}}{\sqrt{{\sum }_{i} {r}_{ai}^{2}} \sqrt{{\sum }_{i} {r}_{bi}^{2}}} \frac{2 {N}_{a , b}}{{N}_{a} + {N}_{b}} \qquad ( 7 )$$

where: a is a current user, b is a specific first user, and i is a second user jointly related to a and b, i.e., a and b are engaged in operating behavior directed at second user i;

rₐᵢ corresponds to the total number of operating actions performed by current user a at second user i;

r_{bi} corresponds to the total number of operating actions performed by specific first user b at second user i;

N_{a,b} corresponds to the number of second users i jointly related to current user a and specific first user b;

Nₐ corresponds to the total number of second users jointly related to the current user a; and

N_{b} corresponds to the total number of second users jointly related to specific first user b.

After calculating the similarity between the current user and each specific first user, in some embodiments, the system confirms specific first users having a similarity value satisfying a definite condition (e.g., exceeding a threshold value) as target specific first users similar to the current user.

In some embodiments, if each first user micro-group has its own set of specific first users, then the system performs the following: during the selecting of similar target specific first users, the system searches target specific first users similar to the current user within the set of specific first users corresponding to the micro-group associated with the current user.

In 130, the system provides recommendation information to the current user based on the operating behavior information of the target specific first users.

After finding specific first users similar to the current user, the system selects recommended information for the current user based on the historical operating behavior information of the similar specific first users. In some embodiments, the system limits the number of specific first users similar to the current user. In other words, the system recommends the historical operating behavior information of specific first users to current users only when the number of specific first users similar to the current user is greater than or equal to a threshold value. If the system looks up target specific first users similar to the current user in a set of specific first users corresponding to the micro-group associated with the current user, and if the number of target specific first users that were looked up is less than the threshold value, the system looks up target in-group first users similar to the current user in all the first users of this micro-group and recommends information to the current user based on these target in-group first users. In other words, since first users in the same micro-group typically have shared operating behaviors, in cases where only a very few specific first users similar to a current user exist, obtaining recommendation results that satisfy the current user by making recommendations based on data on all first users in the micro-group is possible. If the similarity is calculated based on all first users in a micro-group, the computation volume is to be larger than the computation volume would have been for similarity calculated based on the set of specific first users of the micro-group. Using the technique described herein, the computation volume is much smaller than for similarity calculations based on all first users. Moreover, the probability that the recommendation results will satisfy the current user is greater when recommendations are based on the operating behavior information of other in-group specific first users belonging to the same micro-group.

In order to recommend information to the current user after acquiring the target specific first users similar to the current user, the system first acquires second users related to each target specific first user and then recommends to the current user the information, services, etc. the related second user can provide.

For example, if the system recommends information based on historical purchasing behavior information of superior buyer-users who serve as target specific first users, then the system identifies which shops these target superior buyer-users engage in purchasing behavior. In some embodiments, these related shops serve as candidate shops. In other words, shop information or product information capable of being recommended to the current buyer is selected from these candidate shops. After obtaining the candidate shops, the system selects the shops that may be used for recommendation based on a preset condition. Examples of preset conditions include positive feedback rates, return rates, etc. When performing the selection of the shops, the system calculates a score for each related shop based on the similarity in purchasing behavior of the current user to target superior buyer-users and preference level information on the target superior buyer-users with regard to each related shop. Those related shops having scores that satisfy a preset condition serve as the target related shops. The preference level information on target superior buyer-users relating to each related shop is related to the number of purchases by target superior buyer-users at related shops. For example, the following formula (8) is used to calculate the score for each candidate shop:

$$\frac{{\sum }_{b} {r}_{bi} sim ( a , b )}{{\sum }_{b} {r}_{bi} {\sum }_{b} sim ( a , b )} \qquad ( 8 )$$

wherein:

a corresponds to a current user;

b corresponds to a target superior buyer-user similar to current user a;

i corresponds to a shop related to the target superior buyer-user who is similar to current user a;

r_{bi} corresponds to the number of orders placed by buyer-user b for purchases at shop i; and

sim (a, b) corresponds to the similarity between current user a and target superior buyer-user b; the calculation result in formula (7) may be directly used to calculate sim (a, b).

After the above-described formula (8) is used to calculate a score for each candidate shop, the system ranks the candidate shops based on their scores. Thus, the system can recommend information on the top N shops to the current user or select some product information from the top N shops to be recommended to the current buyer. The system can select product information based on product sales volume, positive feedback rate, return rate, etc.

In some embodiments, some “small and beautiful” shops are more likely to have a unique style. In some embodiments, in order to give such shops the chance to acquire more recommendations, the system also considers a shop GMV factor when selecting shops to recommend from among candidate shops. In some embodiments, the system gives preference to recommending shops with smaller GMVs where the differences between scores of candidate shops are not large. In addition, when selecting shops to recommend from among the candidate shops, the system also first filters out some shops whose basic attributes do not meet a set of recommendation conditions. For example, the system filters out shops whose hours of operation, ratings, DSR, etc. do not comply with the set of recommendation conditions. Subsequently, the system calculates the scores of the remaining candidate shops based on above formula (8).

In some embodiments, the system selects target users similar to the current user that complies with preset conditions from among a set of specific first users and then recommends information to the current user based on historical operating behavior information on the target users. Because the target users and the current user are similar, a higher probability exists that the ultimate recommendation result will satisfy the current user. In addition, the specific first users are a portion of all first users. Therefore, the computation volume is to be significantly reduced when similarities are being compared. Moreover, in some embodiments, the specific first users are the “elite” among first users. For example, the specific first users are good at finding superior shops of superior sellers. The shops where the specific first users have made purchases typically provide superior services, etc. Therefore, the quality of the recommendation information obtained based on the shops where these specific first users have made purchases can be assured, with the results that the effectiveness of the recommendation results can be increased.

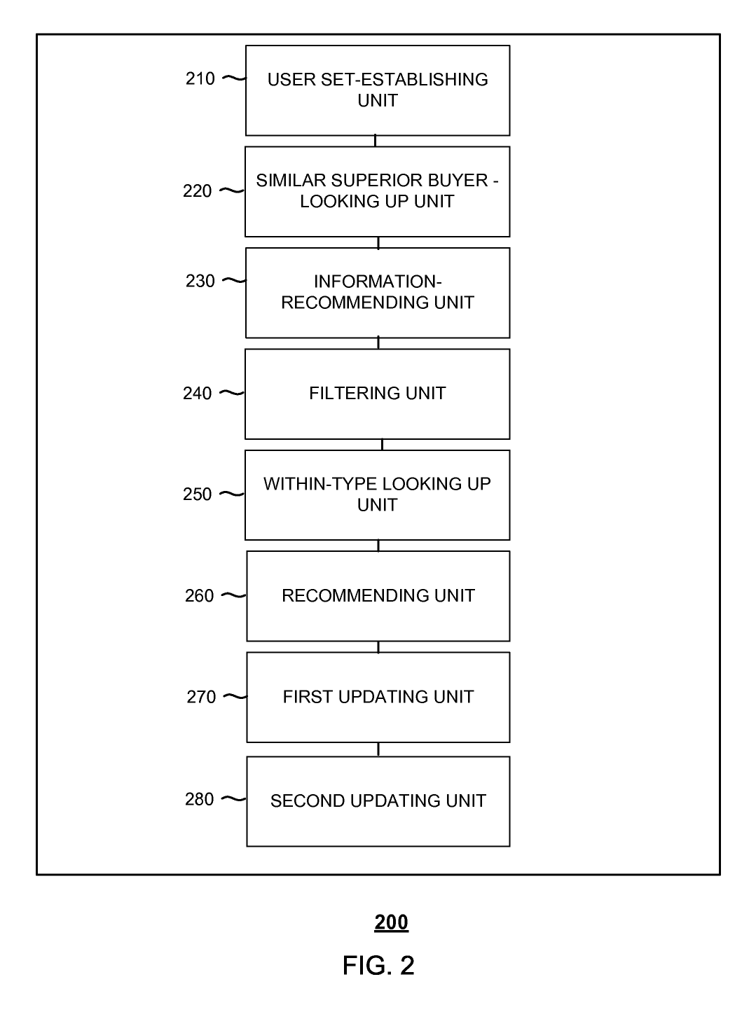

FIG. 2 is a diagram of an embodiment of a device for recommending information. In some embodiments, the device 200 implements the process 100 of FIG. 1C and comprises a user set-establishing unit 210, a similar superior buyer-looking up unit 220, and an information-recommending unit 230.

In some embodiments, the user set-establishing unit 210 acquires a set of specific first users composed of at least one specific first user that complies with a first preset condition based on operating behavior information of all first users recorded in a system.

In some embodiments, the similar superior buyer-looking up unit 220 looks up in the set of specific first users target specific first users having a similarity to the current user that complies with a second preset condition.

In some embodiments, the information-recommending unit 230 provides recommendation information to the current user based on the operating behavior information records of the target specific first users.

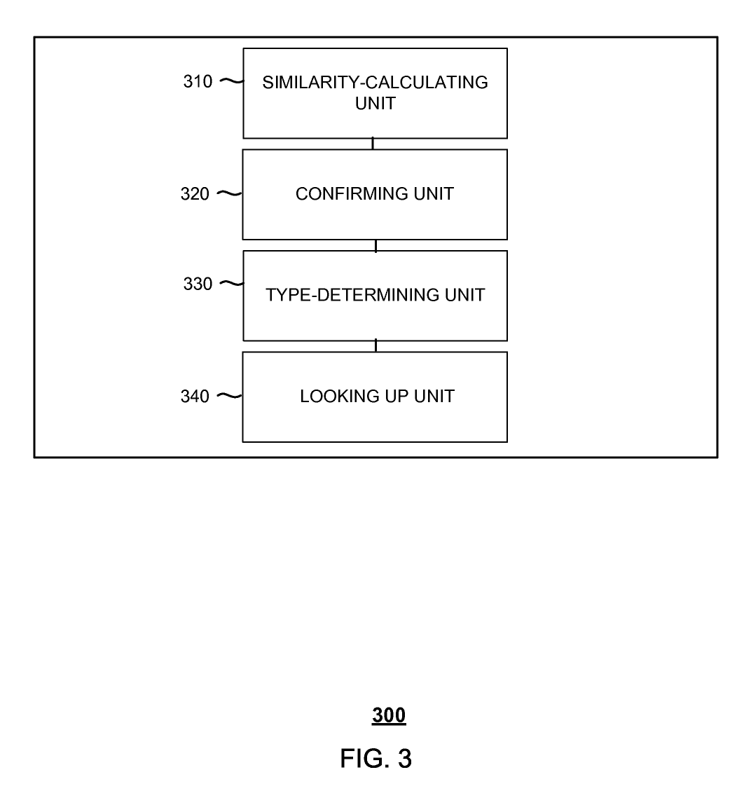

FIG. 3 is a diagram of an embodiment of a similar superior buyer-looking up unit. In some embodiments, the similar superior buyer-looking up unit 300 of FIG. 3 corresponds with the similar superior buyer-looking up unit 220 of FIG. 2 and comprises a similarity-calculating unit 310 and a confirming unit 320.

In some embodiments, the similarity-calculating unit 310 calculates the similarity in operating behavior between the current user and each specific first user based on historical operating behavior information of the current user and the specific first users.

In some embodiments, the confirming unit 320 confirms specific first users having a similarity that complies with the second preset condition as the target specific first users.

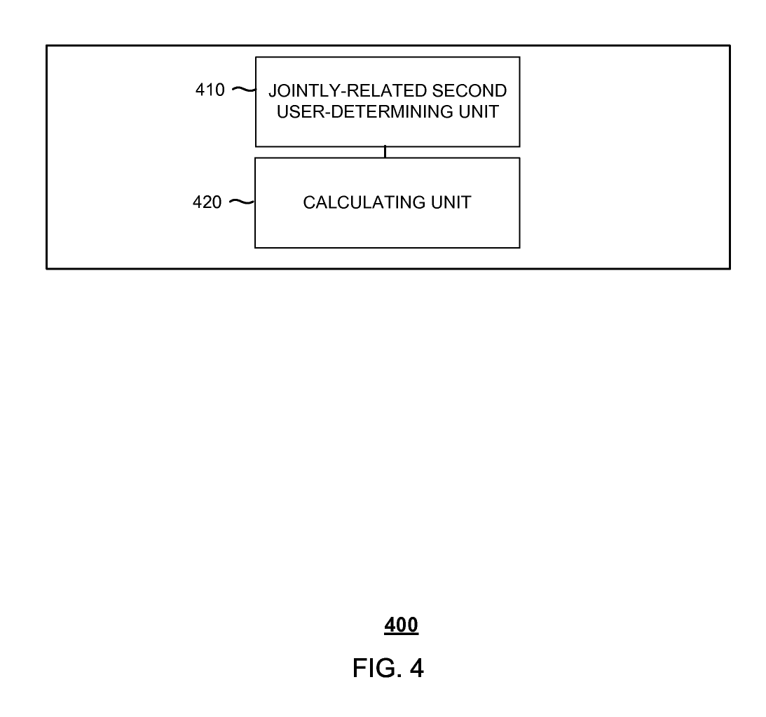

FIG. 4 is a diagram of an embodiment of a similarity-calculating unit. In some embodiments, the similarity-calculating unit 400 of FIG. 4 corresponds with the similarity-calculating unit 310 of FIG. 3 and comprises a jointly-related second user-determining unit 410 and a calculating unit 420.

In some embodiments, the jointly-related second user-determining unit 410 determines second users jointly related to the current user and specific first users. In some embodiments, second users related to a first user refer to second users corresponding to operation objects of the first user (e.g., a buyer engaging in purchasing or other operating behavior at a seller where the seller is a second user corresponding to operating objects of the buyer, and the buyer is accordingly related to the seller).

In some embodiments, the calculating unit 420 calculates the similarity in operating behavior of the current user to specific first users based on the number of the jointly-related second users, the number of operations by the current user and specific first users, respectively, at the jointly related second users, and the total number of second users related to the current user and each specific first user.

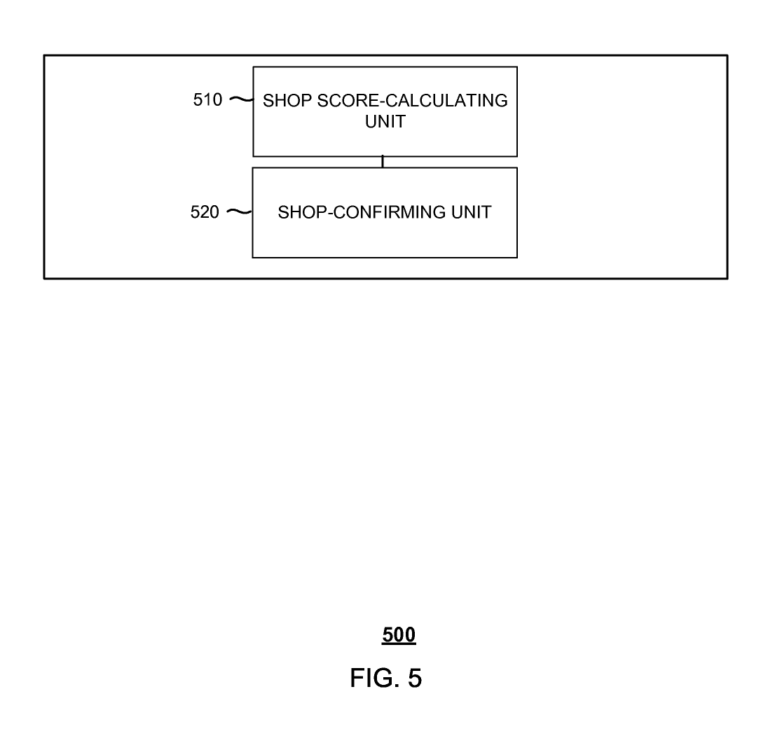

FIG. 5 is a diagram of an embodiment of an information-recommending unit. In some embodiments, the information-recommending unit 500 of FIG. 5 corresponds with the information-recommending unit 230 of FIG. 2 and comprises a shop score-calculating unit 510 and a shop-confirming unit 520.

In some embodiments, the shop score-calculating unit 510 calculates a score for each related second user based on similarity of the current user to the target specific first users and preference level information on the target specific first users with regard to each related second user. In some embodiments, the preference level information is related to the number of purchases by the target specific first users at related second users.

In some embodiments, the shop-confirming unit 520 confirms related second users having a score that satisfies a preset condition as target related second users.

In some embodiments, to enable “small and beautiful” shops to increase their chances for recommendation, the information-recommending unit 500 confirms related second users whose score is higher than a first preset threshold value and whose sales volume within a certain time interval is lower than a second preset threshold value as target related second users.

In addition, in some embodiments, the information-recommending unit 500 filters out second users which are obviously unsuited for recommendation from among candidate second users. In some embodiments, referring back to FIG. 2, the device 200 further comprises a filtering unit 240.

In some embodiments, the filtering unit 240 filters related second users based on basic attributes of each related second user. In some embodiments, the basic attributes include the shop hours of operation, ratings, scores within a scoring system for the related second users, etc.

In some embodiments, all first users are pre-divided into at least two micro-groups according to the basic attributes of first users, with each micro-group having its own set of specific first users. In some embodiments, referring back to FIG. 3, the similar superior buyer-looking up unit 300 further includes a type-determining unit 330 and a looking up unit 340.

In some embodiments, the type-determining unit 330 determines the type to which the current user belongs.

In some embodiments, the looking up unit 340 looks up in the set of specific first users of this type target specific first users having a similarity to the current user that complies with a preset condition.

In some embodiments, referring back to FIG. 2, if, within the set of specific first users of this type, the number of target specific first users having a similarity to the current user that complies with the second preset condition is greater than or equal to a first preset threshold value, the information-recommending unit 230 provides recommendation information to the current user based on the operating behavior information records of the target specific first users.

In some embodiments, the device 200 further comprises a within-type looking up unit 250 and a recommending unit 260.

In some embodiments, if, within the set of specific first users of this type, the number of target specific first users having a similarity to the current user that complies with the second preset condition is smaller than a first preset threshold value, the within-type looking up unit 250 looks up the target first users having a similarity to the current user that complies with the second preset condition among all first users of this type.

In some embodiments, the recommending unit 260 provides recommendation information to the current user based on the historical operating behavior records of the target first users.

In some embodiments, the recommending unit 260 determines at least one specific first user to be in compliance with a first preset condition through the following approach:

The recommending unit 260 determines at least one specific first user complying with a first preset condition based on the operating behavior information of all first users recorded in a system. In some embodiments, the operating behavior information of the first user at least includes whether or not in each operation action the second user related to the first user is a specific second user.

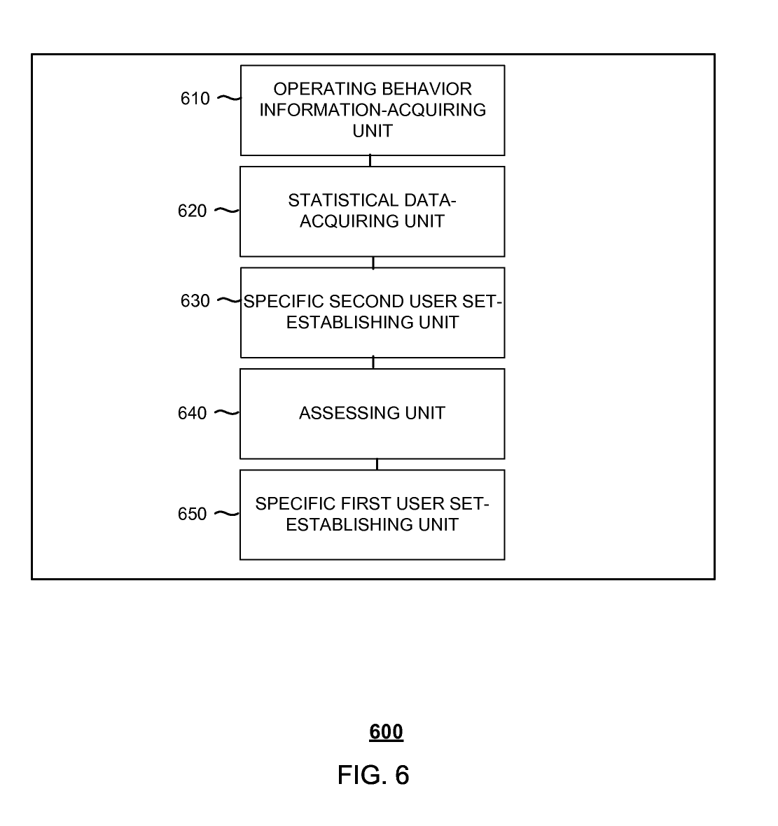

FIG. 6 is a diagram of an embodiment of a recommending unit. In some embodiments, the recommending unit 600 of FIG. 6 corresponds with the recommending unit 260 of FIG. 2 and comprises an operating behavior information-acquiring unit 610, a statistical data-acquiring unit 620, a specific second user set-establishing unit 630, an assessing unit 640, and a specific first user set-establishing unit 650.

In some embodiments, the operating behavior information-acquiring unit 610 acquires operating behavior information on all first users recorded in the system.

In some embodiments, the statistical data-acquiring unit 620 acquires statistical data on all second users recorded in a system. In some embodiments, the statistical data includes values of a plurality of preset second-user variables.

In some embodiments, the specific second user set-establishing unit 630 establishes sets of specific second users based on the values of various second-user variables.

In some embodiments, the assessing unit 640 assesses, in each first-user operating action, whether a second user relating to the first user is a specific second user based on the operating behavior information of the first users and the set of specific second users.

In some embodiments, the specific first user set-establishing unit 650 determines whether each first user is a specific first user and establishes a set of specific first users based on the assessment results and the operating behavior information of the first users.

In some embodiments, referring back to FIG. 2, the device 200 further comprises a first updating unit 270 and a second updating unit 280.

In some embodiments, the first updating unit 270 re-determines whether each first user is a specific first user based on new operating behavior information generated by first users within a designated time interval and whether the related second user in each operating action is a specific second user, and updates the set of specific first users according to the re-determination results.

In some embodiments, the second updating unit 280 re-determines whether each second user is a specific second user based on new operating information generated by second users within a designated time interval and whether related first users in the new operating information are specific first users, and updates the set of specific second users according to the re-determination results.

In some embodiments, while re-determining whether each first user is a specific first user, the following information is relevant: the total number of operations by the first user in the new operating behavior information, the number of related second users which are specific second users in each operation by the first user, the number of operations by the first user at each second user, and the previous-operation calculation result for each second user.

While re-determining whether each second user is a specific second user, the following information is relevant: the number of specific first users related to the second user in the new operating information, the total number of times the second user was subject to specific first user operations, the total number of times the second user was subject to operations by each specific first user, and the previous-operation calculation result for each specific first user.

Referring back to FIG. 6, in some embodiments, after a set of specific second users is established according to the values of various second-user variables, the specific second user set-establishing unit 630 establishes a set of specific second users by:

performing a plurality of clusterings of second users based on each variable and determining those variables which cluster second users into preset types and embody preset distinctness levels between various types as specific variables;

acquiring the weight of each specific variable, the weight being used to represent the importance of each specific variable in embodying the distinctness levels;

establishing a score calculation formula for second users based on the specific variables and each weight thereof; and

substituting the value of each second user with respect to each specific variable into the calculation formula and calculating a score base value of each second user.

In some embodiments, each specific variable weight is acquired by:

scoring each second user based on the specific variables and the initial weight of each specific variable, labeling a preset number of second users with the highest scores in each type as extreme samples of the corresponding type, where the initial weights of all specific variables are equal; and

conducting loop learning a preset number of times, using the semi-supervised classification method, to progressively update the weight of each specific variable, where the following operations are performed during each learning:

updating the weight of each specific variable based on the labeled sample set in each type, where during the first learning, the labeled sample set is composed of the extreme samples; and

calculating the similarities between other second users and each labeled sample, conducting type labeling of second users having a confidence interval satisfying a preset condition to add the newly labeled second user to the labeled sample set of the corresponding type, and making the labeled sample set available for the use of the next semi-supervised classification learning.

To further adjust the weight of each specific variable, the following can also be performed:

conducting loop learning a preset number of times using a semi-supervised regression method to progressively update the weight of each specific variable, where the following operations are performed during each learning:

scoring each sample in the labeled set based on the weight of each specific variable obtained with the semi-supervised learning, where the labeled sample set is composed of the extreme samples during the initial learning;

updating the weight of each specific variable based on the samples in the scored sample set;

calculating the similarities between other second users and each scored sample, scoring second users having a confidence interval that satisfies a preset condition to add the newly scored second user to the scored sample set of the corresponding type, and making the scored sample set available for the use of the next semi-supervised regression learning.

The system comprises an e-commerce transaction platform, and the specific variables that are obtained can comprise: a positive evaluation rate, a ratio of re-occurrence of related behavior information, a product object online close rate, a product object bookmarking rate, a proportion of higher-than-mean scores in a service rating system, a conversion rate of page views from product object detailed information pages, a proportion of page views from internal website searches, a response rate in related instant messaging systems, the time interval from user confirmation of order to shipment of goods, or any combination thereof.

The system comprises an e-commerce transaction platform, and while performing a plurality of clusterings of second users based on each variable, each cluster is a two-dimensional cluster, with second users' sales volume information as one dimension and another variable as the other dimension.

In some embodiments, the system selects target users having a similarity to the current user that complies with a preset condition from among a set of specific first users and then recommending information to the current user based on historical operating behavior information records on the target users. Because the target users and the current user are similar, a higher probability exists that the ultimate recommendation result is to satisfy the current user. In addition, the specific first users are a portion of all first users. Therefore, the computation volume is to be greatly reduced when similarities are compared. Moreover, the specific first users can be the “elite” first users among all first users. For example, the specific first users are good at finding superior shops of superior sellers. The shops where the specific first users have made purchases typically provide superior services, etc. Therefore, the quality of the recommendation information obtained based on the shops where these specific first users have made purchases can be definitely assured, with the result that the effectiveness of the recommendation results is increased.

FIG. 7 is a diagram of an embodiment of a system for recommending information. In some embodiments, in the system 700, a buyer-user using the client 710 sends a request for the recommendation of information to the server 720 via the network 730.

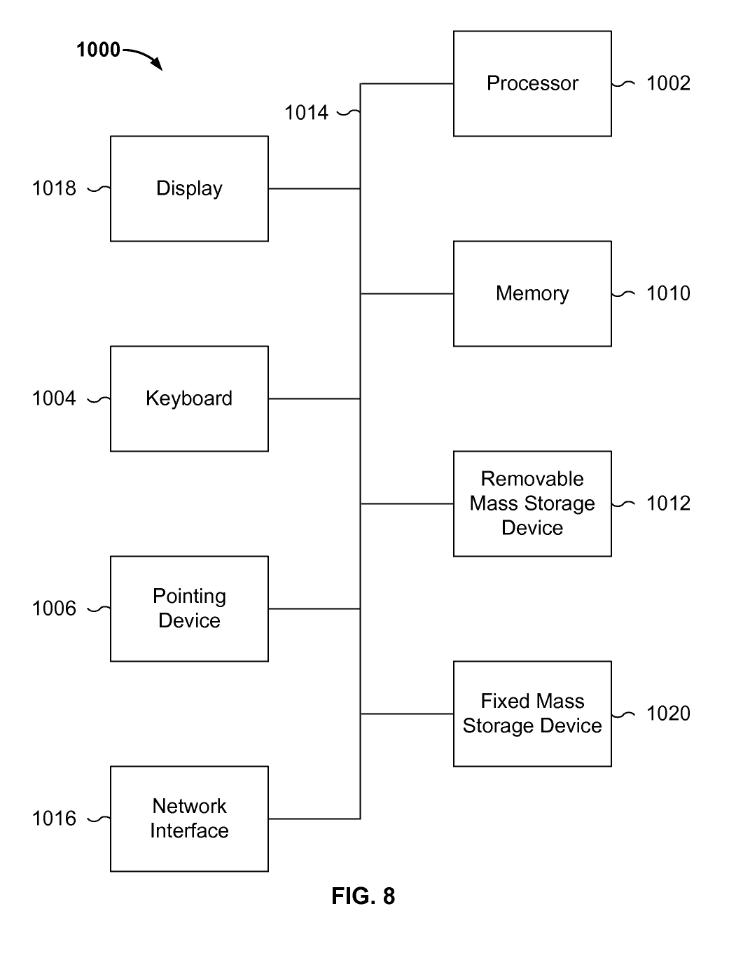

FIG. 8 is a functional diagram of an embodiment of a computer system for recommending information. As will be apparent, other computer system architectures and configurations can be used to recommend information. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data, and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storage 1012, 1020 generally store additional programming instructions, data, and the like that typically are not in active use by the processor 1002. It will be appreciated that the information retained within mass storage 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 8 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The method steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for recommending information, comprising:
determining a set of specific first users comprising at least one specific first user who complies with a first preset condition, the determination being based on operating behavior information of a set of one or more first users recorded in a system;
looking up, using one or more computer processors and in the set of specific first users, targeted specific first users having a similarity to a current user who complies with a second preset condition; and
providing recommendation information to the current user based on the operating to behavior information of the targeted specific first users.

2. The method as described in claim 1, wherein the looking up, in the set of specific first users, of the targeted specific first users having the similarity to the current user who complies with the second preset condition comprises:
calculating a similarity in operating behavior between the current user and each specific is first user based on historical operating behavior information of the current user and the specific first users; and
confirming specific first users having a similarity that complies with the second preset condition as the targeted specific first users.

3. The method as described in claim 2, wherein the calculating of the similarity in the operating behavior between the current user and each specific first user based on the historical operating behavior information of the current user and the specific first users comprises:
determining second users jointly-related to the current user and the specific first users, second users related to a specific first user comprising second users corresponding to operation objects of the specific first user; and
calculating a similarity in operating behavior of the current user to the specific first users based on a number of the jointly-related second users, a number of operations by the current user at jointly-related second users and a number of operations by specific first users at jointly-related second users, a total number of second users related to the current user and each specific first user, or any combination thereof.

4. The method as described in claim 1, wherein:
the set of one or more first users are pre-divided into at least two types according to a basic attribute of the first users, each type having its own set of specific first users; and
the looking up, in the set of specific first users, of the targeted specific first users having a similarity to the current user that complies with the second preset condition comprises:
determining a type to which the current user belongs; and
looking up, in a set of specific first users of the type, targeted specific first users having a similarity to the current user that complies with a third preset condition.

5. The method as described in claim 4, wherein the providing of the recommendation information to the current user based on the operating behavior information of the targeted specific first users comprises:
in the event that, within the set of specific first users of the type, a number of the targeted specific first users having the similarity to the current user that complies with the second preset condition is greater than or equal to a first preset threshold value, providing the recommendation information to the current user based on the operating behavior information of the targeted is specific first users.

6. The method as described in claim 5, wherein the providing of the recommendation information to the current user based on the operating behavior information of the targeted specific first users further comprises:
in the event that, within the set of specific first users of this type, the number of the targeted specific first users having the similarity to the current user that complies with the second preset condition is smaller than the first preset threshold value:
looking up targeted first users having the similarity to the current user that complies with the second preset condition among a set of one or more first users of this type; and
providing the recommendation information to the current user based on the operating behavior information of the targeted first users.

7. The method as described in claim 1, wherein the at least one specific first user that complies with the first preset condition is determined as follows:
determining the at least one specific first user that complies with the first preset condition based on the operating behavior information of the set of one or more first users recorded in the system, wherein the operating behavior information of the set of one or more first users includes whether or not in each operation action a second user related to the first user is a specific second user.

8. The method as described in claim 7, wherein the determining of the at least one specific first user that complies with the first preset condition based on the operating behavior information of the set of one or more first users recorded in the system comprises:
acquiring the operating behavior information of the set of one or more first users recorded in the system;
acquiring statistical data on a set of one or more second users recorded in the system, the statistical data comprising values of a plurality of preset second user variables;
establishing a set of specific second users based on the values of a set of one or more second user variables;
assessing, in each first user operating action, whether the second user relating to the first user is a specific second user based on the operating behavior information of the first users and the set of the specific second users; and
determining whether each first user is a specific first user and establishing the set of specific first users based on the assessment results and the operating behavior information of the first users.

9. The method as described in claim 8, further comprising:
conducting iterative updating of the set of specific first users and the set of specific second users based on the following:
re-determining whether each first user is a specific first user based on new operating behavior information generated by first users within a first designated time interval and whether or not the related second user in each operating action is a specific second user;
updating the set of specific first users according to the re-determination result of each first user;
re-determining whether each second user is a specific second user based on new operating information generated by second users within a second designated time interval and whether related first users in the new operating information are specific first users; and
updating the set of specific second users according to the re-determination result of each second user.

10. The method as described in claim 9, wherein the re-determining of whether each first user is the specific first user is based on a total number of operations by the first user in the new operating behavior information, a number of related second users which are specific second users in each operating action by the first user, a number of operations by the first user at each second user, the previous redetermination result for each second user, or any combination thereof.

11. The method as described in claim 9, wherein the re-determining of whether each second user is the specific second user is based on:
a number of specific first users related to the second user in the new operating information, a total number of times the second user was subject to specific first user operations, a total number of times the second user was subject to operations by each specific first user, the previous redetermination result for each specific first user, or any combination thereof.

12. The method as described in claim 8, wherein the establishing of the set of specific second users based on the values of the set of one or more second user variables comprises:
performing a plurality of clusterings of second users based on each variable, wherein the performing of the plurality of clusterings of second users comprises:
determining the variables that cluster second users into preset types and embody preset distinctness levels between various types as specific variables;
acquiring a weight of each specific variable, the weight being used to correspond to an importance of each specific variable in embodying the preset distinctness levels;
establishing a score calculating formula for second users based on the specific variables and each weight of the specific variable;
calculating a score of each second user using the score calculating formula; and
determining second users having a score that satisfies the first preset condition to be specific second users.

13. The method as described in claim 12, wherein the acquiring of the weight of each specific variable comprises:
scoring each second user based on the specific variables and an initial weight of each specific variable;
labeling a preset number of second users with the highest scores in each type as extreme samples of a corresponding type, wherein the initial weights of a set of one or more specific variables are equal; and
conducting loop learning, using a semi-supervised classification process, a preset number of times based on the extreme samples, to progressively update the weight of each specific variable, wherein the following operations are performed during each learning operation:
updating the weight of each specific variable based on a labeled sample set in each type, wherein, during a first learning, the labeled sample set is composed of the extreme samples;
to calculating similarities between other second users and each labeled sample; and
conducting type labeling of second users having a confidence interval that satisfies a fourth preset condition to add the newly labeled second user to the labeled sample set of the corresponding type and make the labeled sample set available to be used in the next semi-supervised classification learning.

14. The method as described in claim 13, wherein each learning of the conducting of the loop learning, using the semi-supervised classification process, the preset number of times based on the extreme samples, to progressively update the weight of each specific variable, further comprises:
scoring each sample in the labeled set based on the weight of each specific variable obtained with the semi-supervised learning, wherein the labeled set is composed of the extreme samples during the initial learning;
updating the weight of each specific variable based on the samples in the scored sample set;
calculating the similarities between other second users and each scored sample; and
scoring second users having a confidence interval that satisfies a preset condition to add the newly scored second user to the scored sample set of the corresponding type and make the scored sample set available to be used in a next semi-supervised regression learning.

15. The method as described in claim 12, wherein:
the system comprises an e-commerce transaction platform; and
the specific variables comprise the following variables: a positive evaluation rate, a ratio of re-occurrence of related behavior information, a product object online close rate, a product object bookmarking rate, a proportion of higher-than-mean scores in a service rating system, conversion rate of page views from product object detailed information pages, proportion of page views from internal website searches, response rate in related instant messaging systems, a time interval from user confirmation of order to shipment of goods, or any combination thereof.

16. The method as described in claim 12, wherein:
the system comprises an e-commerce transaction platform; and
each cluster is a two-dimensional cluster, with sales volume information of the second users being one dimension and another variable is the other dimension.

17. The method as described in claim 8, wherein:
the system comprises an e-commerce transaction platform;
the set of one or more first users corresponds to buyers;
the set of one or more second users corresponds to sellers; and
the recommendation information corresponds to product recommendation information.

18. The method as described in claim 1, wherein the first preset condition includes making an amount of purchases above a first threshold, viewing a number of products above a second threshold, or any combination thereof.

19. A system for recommending information, comprising:
at least one processor configured to:
determine a set of specific first users comprising at least one specific first user who complies with a first preset condition, the determination being based on operating behavior information of a set of one or more first users recorded in a system;
look up, in the set of specific first users, targeted specific first users having a similarity to a current user who complies with a second preset condition; and
provide recommendation information to the current user based on the operating behavior information of the targeted specific first users; and
a memory coupled to the at least one processor and configured to provide the at least one processor with instructions

20. A computer program product for recommending information, the computer program product being embodied in a tangible non-transitory computer readable storage medium and comprising computer instructions for:
determining a set of specific first users comprising at least one specific first user who complies with a first preset condition, the determination being based on operating behavior information of a set of one or more first users recorded in a system;
looking up, in the set of specific first users, targeted specific first users having a similarity to a current user who complies with a second preset condition; and
providing recommendation information to the current user based on the operating to behavior information of the targeted specific first users.
